(19) United States
(12) Patent Application Publication
(10) Pub. No.: US 2013/0162593 A1
(43) Pub. Date: Jun. 27, 2013

(54) PROJECTED CAPACITIVE TOUCH PANEL AND COORDINATE DETECTING METHOD THEREOF

(71) Applicant: Futaba Corporation, Chiba-ken (JP)

(72) Inventor: Yawara INOUE, Chiba-ken (JP)

(73) Assignee: Futaba Corporation, Chiba-ken (JP)

(21) Appl. No.: 13/717,990

(22) Filed: Dec. 18, 2012

(30) Foreign Application Priority Data
Dec. 21, 2011 (JP) 2011280575

(51) Int. Cl. G06F 3/044

(52) U.S. Cl. CPC G06F 3/044
USPC 345/174

(57) ABSTRACT

A projected capacitive touch panel includes a touch sensor unit in which X electrodes and Y electrodes are arranged to intersect each other and a controller. The controller has: X electrode and Y electrode storage units which respectively store capacitance variations of the X electrodes and the Y electrodes detected by scanning the X electrodes and the Y electrodes N times; X electrode and Y electrode capacitance variation adding units which respectively add the capacitance variations of the X electrodes and the Y electrodes; and a center coordinates calculating unit which calculates center coordinates of a position where a conductor touches the touch sensor unit by using the added capacitance variations.

### FIELD OF THE INVENTION

The present invention relates to a projected capacitive touch panel and a coordinate detecting method thereof.

### BACKGROUND OF THE INVENTION

A projected capacitive touch panel is configured such that a plurality of X electrodes and a plurality of Y electrodes transparent to the display surface of a display are arranged to intersect each other (e.g., perpendicular to each other), and coordinates of a position where a conductor (e.g., human finger) touches are detected by detecting capacitance variations generated between the finger and the X and Y electrodes when the finger touches a transparent cover of the touch panel.

A projected capacitive touch panel that is generally used conventionally will be described with reference to FIGS. 4A to 4C.

FIG. 4A is a block diagram showing a configuration of a projected capacitive touch panel, FIG. 4B is a diagram showing a structure (shape) of electrodes, and FIG. 4C is an enlarged view of a portion where X electrodes X3 to X7 and Y electrodes Y3 and Y4 intersect each other.

In FIG. 4A, the touch panel includes a touch sensor unit 1 and a controller 2. The touch sensor unit 1 includes a plurality of X electrodes X1 to Xn (n is equal to or greater than 2) and a plurality of Y electrodes Y1 to Ym (m is equal to or greater than 2). The X electrodes X1 to Xn and the Y electrodes Y1 to Ym are arranged to intersect each other (perpendicular to each other). The X electrodes and the Y electrodes may be formed separately on both front and back surfaces of one transparent plate of glass or plastic, may be formed side by side on the same surface of one transparent plate, or may be formed separately on two transparent plates.

Each of the X electrodes X1 to Xn includes a number of rectangular touch response units XS and connecting portions XC as in the X electrode Xj of FIG. 4B. Each of the Y electrodes Y1 to Ym includes a number of rectangular touch response units YS and connecting portions YC as in the Y electrode Y1 of FIG. 4B. The shape of the touch response units is not limited to a rectangular shape.

In FIG. 4C, the touch response unit of the X electrode is surrounded by four touch response units of the Y electrodes, and the touch response unit of the Y electrode is surrounded by four touch response units of the X electrodes. When the X electrodes and the Y electrodes are arranged as shown in FIG. 4C, since the touch response units of the X electrodes and the touch response units of the Y electrodes do not overlap each other in the direction of the display surface of a display (not shown), the transmittance of the touch sensor unit 1 increases, and the visibility of the touch panel to the display surface of the display is improved.

The controller 2 includes an X electrode control unit 21X, a Y electrode control unit 21Y, an X electrode capacitance variation detecting unit 22X, a Y electrode capacitance variation detecting unit 22Y, and a center coordinates calculating unit 23.

The X electrode control unit 21X sequentially selects the X electrodes X1 to Xn by scanning the X electrodes X1 to Xn at a predetermined cycle. The Y electrode control unit 21Y sequentially selects the Y electrodes Y1 to Ym by scanning the Y electrodes Y1 to Ym at a predetermined cycle.

The X electrode capacitance variation detecting unit 22X detects the capacitance variation when the finger touches the touch sensor unit 1 by measuring the capacitance of the X electrodes X1 to Xn. Since a predetermined capacitance (parasitic capacitance) is generated in the X electrodes X1 to Xn even when the finger does not touch the touch sensor unit 1 (during non-touch), the X electrode capacitance variation detecting unit 22X compares the measured capacitance to the capacitance during non-touch and detects the variation as a response value according to the touch of the finger.

The detection of the capacitance variation can be obtained by repeating the operations of charging electrical charges in an integration circuit via the parasitic capacitance (capacitor) of the touch sensor unit 1 and discharging the electrical charges when exceeding a certain threshold voltage by using, e.g., a digital sigma modulator, and counting charges and discharges per unit time to obtain the frequency of repetition of charge and discharge. When the finger touches the touch sensor unit 1, the repetition frequency changes. Generally, the variation of the repetition frequency is referred to as a Diff count value. The Y electrode capacitance variation detecting unit 22Y detects the capacitance variation of each of the Y electrodes similarly to the X electrode capacitance variation detecting unit 22X.

The center coordinates calculating unit 23 calculates the center coordinates of a position where the finger touches on the touch sensor unit 1 based on the capacitance variations of the X electrodes X1 to Xn and the Y electrodes Y1 to Ym detected by the X electrode capacitance variation detecting unit 22X and the Y electrode capacitance variation detecting unit 22Y to detect the coordinates of the position, and generates output coordinates 24.

In the touch sensor unit 1 of FIG. 4A, since the touch response units of the X electrodes and the touch response units of the Y electrodes do not overlap each other, the visibility is improved. On the other hand, when the finger touches the touch sensor unit 1, or when the finger is close to the touch sensor unit 1 similarly to the touch, the X electrode or Y electrode may not respond to the touch. For example, when the finger touches lightly, or when a child's finger touches, since the area (touch area) where the finger is in contact with the touch sensor unit 1 is small, either the X electrode or the Y electrode may not respond to the touch. Further, even when the area of the touch response unit of the X electrode and the Y electrode is too large compared to the touch area, either the X electrode or the Y electrode may not respond to the touch. When the X electrode or Y electrode does not respond to the touch of the finger, the coordinates of the position where the finger touches cannot be detected, and a so-called omission of coordinates occurs.

In order to avoid the omission of coordinates, the number of X electrodes and Y electrodes may be increased by reducing the size of X electrodes and Y electrodes. However, if the number of X electrodes and Y electrodes increases, the cost of the controller 2 becomes high.

Accordingly, as shown in FIG. 5, there have been proposed electrodes having a structure in which the touch response units of X electrodes and Y electrodes are subdivided to be formed in the comb shape such that the comb-shaped portions of the X electrodes and the Y electrodes are arranged to engage with each other (see, e.g., Japanese Patent Application Publication No. 2010-198586).

In the case of FIG. 5, each of the X electrodes X1 to X4 is configured to include a plurality of comb-shaped portions which protrude laterally. Each of the Y electrodes Y1 to Y3 is configured to include three members connected in series in the horizontal direction and having six comb-shaped portions formed in the left and right directions, and two members arranged on both sides and having three comb-shaped portions formed in one direction.

In the X electrodes X1 to X4 and the Y electrodes Y1 to Y3 of FIG. 5, a large number of comb-shaped portions engaging with each other are formed to substantially reduce the touch response units of the X electrodes and the Y electrodes, thereby making the size of the touch response units relatively smaller than the touch area of the finger. However, the structure of the electrodes becomes complicated, and it is difficult to form the electrodes.

### SUMMARY OF THE INVENTION

In view of the above, the present invention provides a projected capacitive touch panel in which omission of coordinates does not occur without subdividing touch response units of X electrodes and Y electrodes and a coordinate detecting method thereof.

In accordance with an aspect of the present invention, there is provided a projected capacitive touch panel including a touch sensor unit in which X electrodes X1 to Xn (n is equal to or greater than 2) and Y electrodes Y1 to Ym (m is equal to or greater than 2) are arranged to intersect each other, and a controller. The controller has: X electrode and Y electrode temporary storage units which respectively store capacitance variations of the X electrodes X1 to Xn and the Y electrodes Y1 to Ym detected by scanning the X electrodes X1 to Xn and the Y electrodes Y1 to Ym N times (N is equal to or greater than 2); X electrode and Y electrode capacitance variation adding units which respectively add the capacitance variations of the X electrode and Y electrode temporary storage units; and a center coordinates calculating unit which calculates center coordinates of a position where a conductor touches the touch sensor unit by using the capacitance variations added by the X electrode and Y electrode capacitance variation adding units and detects coordinates of the position.

Touch response units of the X electrodes X1 to Xn and touch response units of the Y electrodes Y1 to Ym may be arranged such that the touch response units do not overlap each other in a direction of a display surface of a display.

In accordance with another aspect of the present invention, there is provided a coordinate detecting method of a projected capacitive touch panel including a touch sensor unit in which X electrodes X1 to Xn (n is equal to or greater than 2) and Y electrodes Y1 to Ym (m is equal to or greater than 2) are arranged to intersect each other, and a controller. The method includes: respectively storing, in X electrode and Y electrode temporary storage units, capacitance variations of the X electrodes X1 to Xn and the Y electrodes Y1 to Ym detected by scanning the X electrodes X1 to Xn and the Y electrodes Y1 to Ym N times (N is equal to or greater than 2); respectively adding the capacitance variations of the X electrode and Y electrode temporary storage units by X electrode and Y electrode capacitance variation adding units; and calculating center coordinates of a position where a conductor touches the touch sensor unit by a center coordinates calculating unit by using the capacitance variations added by the X electrode and Y electrode capacitance variation adding units and detecting coordinates of the position.

Touch response units of the X electrodes X1 to Xn and touch response units of the Y electrodes Y1 to Ym are arranged such that the touch response units do not overlap each other in a direction of a display surface of a display.

### BRIEF DESCRIPTION OF THE DRAWINGS

The objects and features of the present invention will become apparent from the following description of embodiments, given in conjunction with the accompanying drawings, in which:

FIG. 1 is a block diagram showing a configuration of a projected capacitive touch panel in accordance with an embodiment of the present invention;

FIGS. 2A to 2C and FIGS. 3A to 3E illustrate capacitance variations generated in electrodes of a touch sensor unit of FIG. 1;

FIGS. 4A to 4C show a configuration of a conventional projected capacitive touch panel; and

FIG. 5 is a diagram showing a structure (shape) of electrodes of the conventional projected capacitive touch panel.

### DETAILED DESCRIPTION OF THE EMBODIMENTS

In a projected capacitive touch panel in accordance with an embodiment of the present invention, capacitance variations of X electrodes X1 to Xn (n is equal to or greater than 2) and Y electrodes Y1 to Ym (m is equal to or greater than 2) detected whenever scanning the X electrodes X1 to Xn and the Y electrodes Y1 to Ym are stored in a temporary storage (memory) unit. The capacitance variations detected by N scans (N is equal to or greater than 2, e.g., 3) are added. The center coordinates of a position where a finger touches a touch sensor unit are calculated based on the added capacitance variations of N scans, and the coordinates of the position are detected. That is, in the embodiment of the present invention, the center coordinates are calculated by adding the capacitance variations detected by N scans and treating the added variations as variations detected by one scan.

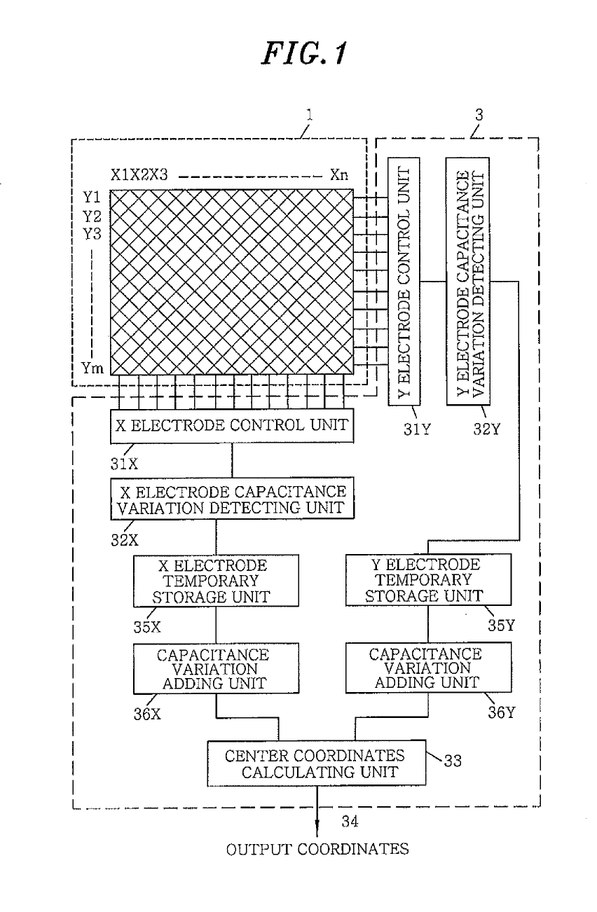

A projected capacitive touch panel in accordance with an embodiment of the present invention will be described with reference to FIG. 1.

The touch panel includes a touch sensor unit 1 and a controller 3.

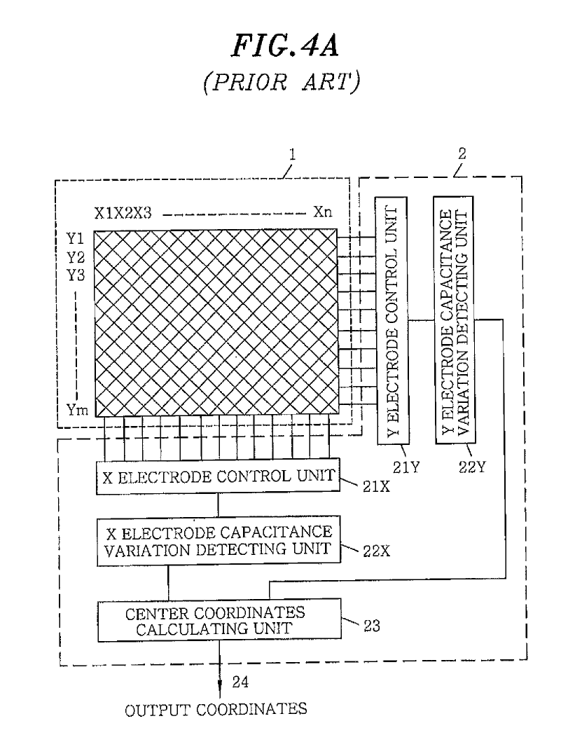

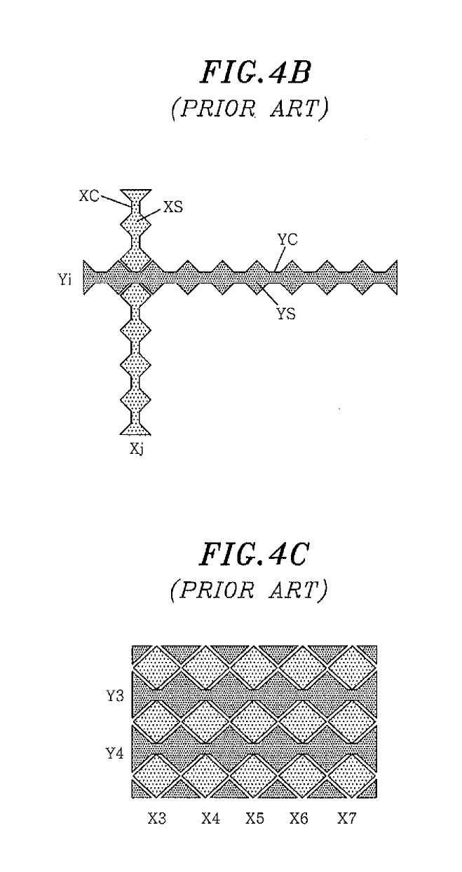

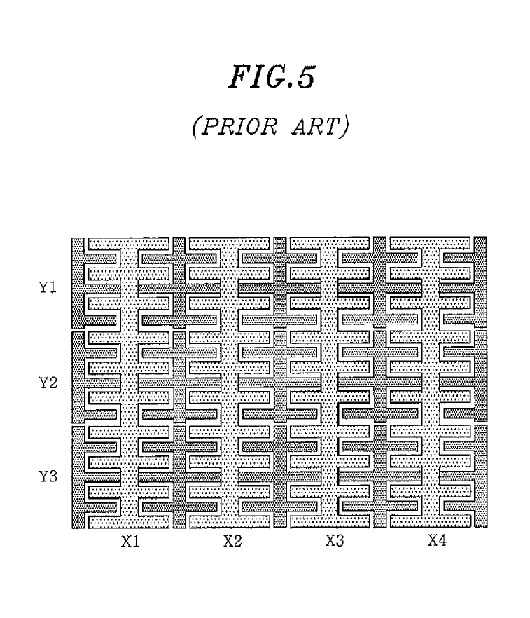

Since the touch sensor unit 1 and the structure (shape) of X electrodes and Y electrodes forming the touch sensor unit 1 are the same as those shown in FIG. 4, a description thereof will be omitted.

The controller 3 includes an X electrode control unit 31X, a Y electrode control unit 31Y, an X electrode capacitance variation detecting unit 32X, a Y electrode capacitance variation detecting unit 32Y, an X electrode temporary storage (memory) unit 35X, a Y electrode temporary storage (memory) unit 35Y, an X electrode capacitance variation adding unit 36X, a Y electrode capacitance variation adding unit 36Y, and a center coordinates calculating unit 33.

Since the X electrode control unit 31X, the Y electrode control unit 31Y, the X electrode capacitance variation detecting unit 32X, and the Y electrode capacitance variation detecting unit 32Y of the controller 3 are the same as the X electrode control unit 21X, the Y electrode control unit 21Y, the X electrode capacitance variation detecting unit 22X, and the Y electrode capacitance variation detecting unit 22Y of FIG. 4, a description thereof will be omitted.

The X electrode temporary storage unit 35X includes three memories which temporarily store the capacitance variations of the X electrodes X1 to Xn when the X electrodes X1 to Xn are scanned N times (N=3 in this embodiment). That is, the X electrode temporary storage unit 35X can store the capacitance variations of three scans. The capacitance variations are stored in the three memories such that old capacitance variations are erased and new capacitance variations are stored as scanning proceeds. Accordingly, the capacitance variations detected by a current scan, a previous scan and a scan before the previous scan are stored in the three memories. The Y electrode temporary storage unit 35Y includes three memories which temporarily store the capacitance variations of the Y electrodes Y1 to Ym detected by scanning the Y electrodes Y1 to Ym three times, similarly to the X electrode temporary storage unit 35X.

The X electrode capacitance variation adding unit 36X adds the capacitance variations stored in the three memories of the X electrode temporary storage unit 35X and treats the added capacitance variations as capacitance variations detected in one scan. Similarly, the Y electrode capacitance variation adding unit 36Y adds the capacitance variations stored in the three memories of the Y electrode temporary storage unit 35Y and treats the added capacitance variations as capacitance variations obtained in one scan.

The center coordinates calculating unit 33 calculates the center coordinates of a position where the finger touches on the touch sensor unit 1 by using the capacitance variations obtained by the X electrode capacitance variation adding unit 36X and the capacitance variations obtained by the Y electrode capacitance variation adding unit 36Y to generate output coordinates 34.

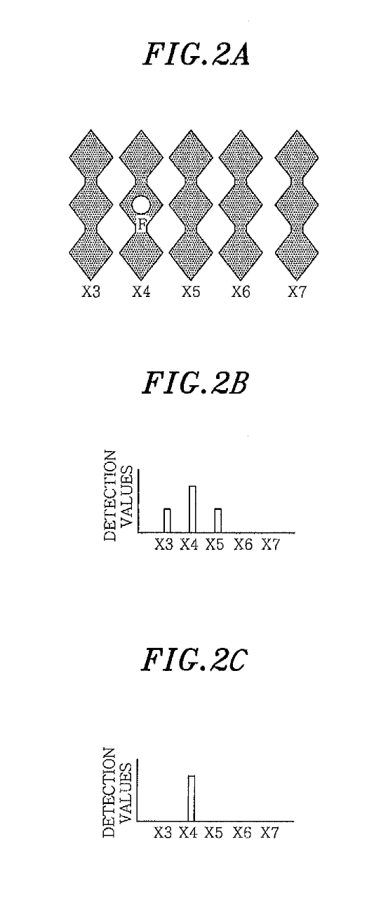

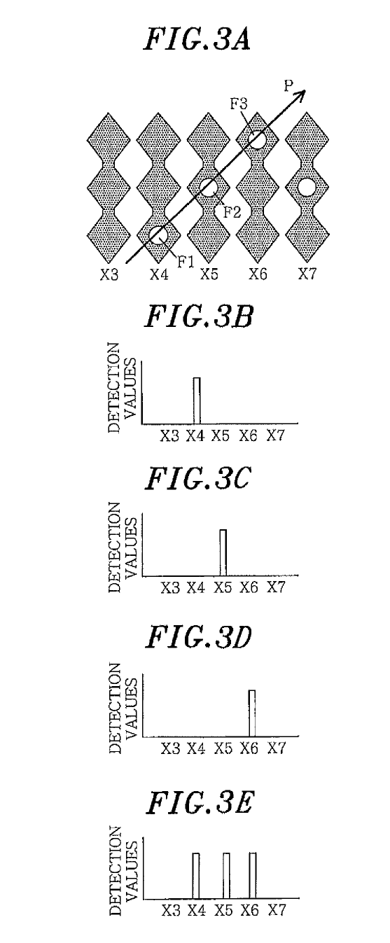

The capacitance variation generated in each electrode of the touch sensor unit 1 of FIG. 1 will be described with reference to FIGS. 2A to 3E.

First, FIGS. 2A to 20 will be described.

FIG. 2A represents the arrangement of the X electrodes X3 to X7, and FIGS. 2B and 2C represent capacitance variations of the electrodes, which occurs when the finger touches the X electrode X4. In FIGS. 2B and 2C, a horizontal axis represents the X electrodes X3 to X7, and a vertical axis represents the detection values of the capacitance variations. Further, the Y electrodes are omitted.

The touch area when the finger touches the touch sensor unit 1 differs between a case where the finger touches with a normal strength and a case where the finger touches lightly or the finger is small. The touch area is large in the former case, and small in the latter case (when the area of each electrode (touch response unit) is larger than the touch area of the finger).

The capacitance variations of the X electrodes X3 to X7 when a finger F touches the X electrode X4 with a normal strength and when the finger F touches the X electrode X4 lightly in FIG. 2A will be described.

First, in FIG. 2A, when the finger F touches the X electrode X4 with a normal strength, the X electrode X4 and the X electrodes X3 and X5 on both sides thereof respond to the touch, and the capacitance of each of the X electrodes X3, X4 and X5 changes as in FIG. 2B. When the finger F touches the X electrode X4, the X electrode X4 responds the most strongly and exhibits the largest capacitance variation, and the capacitance variations of the X electrodes X3 and X5 are smaller than that of the X electrode X4. Further, in this case, the Y electrodes (not shown) adjacent to the touch position of the finger F also respond to the touch and vary their capacitance. Accordingly, when the finger F touches with a normal strength, the center coordinates of the position where the finger F touches can be calculated by using the capacitance variations, thereby detecting the coordinates of the position.

Meanwhile, in FIG. 2A, when the finger F touches the X electrode X4 lightly, a case where only the X electrode X4 responds and the X electrodes X3 and X5 do not respond may occur as in FIG. 20. In this case, the Y electrodes (not shown) adjacent to the touch position of the finger F also may not respond. Thus, in this case, it may be impossible to accurately detect the coordinates of the position where the finger touches.

Next, FIGS. 3A to 3E will be described.

FIG. 3A shows an example in which the finger moves in the direction of arrow P. When the finger moves, the finger sequentially touches the X electrodes X4, X5 and X6 and the Y electrodes (not shown).

In FIG. 3A, when the finger touches the X electrodes X4, X5 and X6 with a normal strength, the X electrode where the finger touches and the X electrodes on both sides thereof respond to the touch in the same manner as FIG. 2B. However, when the finger touches the X electrodes X4, X5 and X6 lightly, only the X electrode where the finger touches responds in the same manner as in FIG. 2C, and the capacitance of each electrode varies as in FIGS. 3B to 3D. Further, the Y electrodes (not shown) adjacent to the positions of the fingers F1, F2 and F3 respond in the same manner as the response of Y electrodes that has been described in FIG. 2A.

Thus, in FIG. 3A, when the finger touches the X electrodes X4, X5 and X6 lightly, it may be impossible to accurately detect the coordinates of the position where the finger touches as in FIG. 2C.

Accordingly, in this embodiment, focusing on the fact that FIG. 3E can be obtained with capacitance variations similar to that in FIG. 2B when adding the capacitance variations of FIGS. 3B to 3D, the center coordinates are calculated by adding the capacitance variations detected by scanning the X electrodes X1 to Xn of the touch sensor unit 1 three times, and treating the added capacitance variations of three scans as capacitance variations detected in one scan. Similarly, also with regard to the Y electrodes Y1 to Ym, the center coordinates are calculated by adding the capacitance variations detected by scanning the Y electrodes Y1 to Ym three times, and treating the added capacitance variations of three scans as capacitance variations detected in one scan.

In the present embodiment, the capacitance variations detected by scanning the X electrodes X1 to Xn and the Y electrodes Y1 to Ym of the touch sensor unit 1 three times are added, and the added capacitance variations of three scans are treated as capacitance variations of the X electrodes and those of the Y electrodes detected in one scan. Then, the coordinates of the position where the finger touches are detected by using the added capacitance variations of the electrodes of both sides. Accordingly, even when the finger touches the touch sensor unit 1 lightly, the coordinates can be detected similarly to when the finger touches with a normal strength, and the frequency of omitting coordinates is reduced.

Further, in this embodiment, even when the finger touches the touch sensor unit 1 lightly, it becomes equivalent to a state where the electrodes on both sides of the electrode where the finger touches also respond to the touch as when the finger touches with a normal strength. Thus, the coordinates of the position where the finger actually touches can be accurately detected, and the resolution of coordinate detection increases.

Further, in the present embodiment, since the capacitance variations of three scans are added and treated as capacitance variations of one scan, the coordinates detected when the finger moves in the direction of arrow P and is located on the electrode X6 (position of finger F3) are coordinates corresponding to the electrode X5 (position of finger F2), which are coordinates one scan earlier than the position of finger F3. That is, the detected coordinates are coordinates corresponding to the electrode X5 adjacent to the electrode X6 where the finger touches. This delay of coordinate detection hardly makes an operator of the touch panel feel uncomfortable.

An example of adding the capacitance variations detected by scanning the X electrodes and the Y electrodes three times has been described in the above embodiment, but the number of scans is not limited to three, and may be N (N is equal to or greater than 2). Meanwhile, as the number of scans increases, the time required to add the capacitance variations or calculate the center coordinates becomes long.

Accordingly, when taking into account the fact that when the finger touches the touch sensor unit with a normal strength, the electrode where the finger touches and the electrodes on both sides thereof respond to the touch and the exact coordinates of the touch position can be detected, it is preferable that the number of scans may be three.

Although a rectangular touch response unit has been described as an example in the above embodiment, the shape of the touch response unit is not limited to a rectangular shape. However, if the shape of the touch response unit is a rectangular shape, since it is possible to reduce a vacant space between the X electrodes and the Y electrodes, the detection sensitivity of the touch of the finger becomes higher.

Although a case where a conductor which touches the touch sensor unit is a human finger has been exemplified in the above embodiment, it may be a conductor other than the finger.

Although a projected capacitive touch panel including a touch sensor unit configured such that the touch response units of the X electrodes and the Y electrodes do not overlap each other in the direction of the display surface of the display has been described in the above embodiment, the present invention may be also applied to a projected capacitive touch panel including a touch sensor unit in which the X electrodes and the Y electrodes are disposed to overlap each other. In case of the touch sensor unit in which the X electrodes and the Y electrodes are disposed to overlap each other, omission of coordinates does not occur frequently. However, when the present invention is applied thereto, the resolution when detecting the coordinates of the touch position of the finger increases.

In the present invention, the capacitance variations detected by scanning the X electrodes and Y electrodes N times are added. The added capacitance variations of N scans are treated as capacitance variations of the electrodes on both sides detected by one scan. The coordinates of a position where the finger touches the touch sensor unit are detected by using the added capacitance variations of the electrodes on both sides. Accordingly, even when the touch area is small such as when the finger touches the touch sensor unit lightly and when the finger is small, the coordinates can be detected as when the finger touches with a normal strength. Thus, it is possible to prevent omission of coordinates. Particularly, it is preferable in coordinate detection when the finger moves.

Further, in the present invention, even when the touch area is small such as when the finger touches the touch sensor unit lightly, the coordinates can be detected in a state equivalent to the state where the electrode where the finger touches and the electrodes on both sides thereof respond to the touch as when the finger touches with a normal strength. Thus, the coordinates of the position where the finger actually touches can be accurately detected, and the resolution of coordinate detection increases.

The effect of the present invention (prevention of the omission of coordinates or high resolution) is larger particularly when the electrodes are disposed such that the touch response units of the X electrodes and the Y electrodes do not overlap each other.

While the invention has been shown and described with respect to the embodiments, it will be understood by those skilled in the art that various changes and modification may be made without departing from the scope of the invention as defined in the following claims.

What is claimed is:

1. A projected capacitive touch panel comprising a touch sensor unit in which X electrodes X1 to Xn (n is equal to or greater than 2) and Y electrodes Y1 to Ym (m is equal to or greater than 2) are arranged to intersect each other, and a controller,
wherein the controller includes:
X electrode and Y electrode temporary storage units which respectively store capacitance variations of the X electrodes X1 to Xn and the Y electrodes Y1 to Ym detected by scanning the X electrodes X1 to Xn and the Y electrodes Y1 to Ym N times (N is equal to or greater than 2);
X electrode and Y electrode capacitance variation adding units which respectively add the capacitance variations of the X electrode and Y electrode temporary storage units; and
a center coordinates calculating unit which calculates center coordinates of a position where a conductor touches the touch sensor unit by using the capacitance variations added by the X electrode and Y electrode capacitance variation adding units and detects coordinates of the position.

2. The projected capacitive touch panel of claim 1, wherein touch response units of the X electrodes X1 to Xn and touch response units of the Y electrodes Y1 to Ym are arranged such that the touch response units do not overlap each other in a direction of a display surface of a display.

3. A coordinate detecting method of a projected capacitive touch panel including a touch sensor unit in which X electrodes X1 to Xn (n is equal to or greater than 2) and Y electrodes Y1 to Ym (m is equal to or greater than 2) are arranged to intersect each other, and a controller, the method comprising:
respectively storing, in X electrode and Y electrode temporary storage units, capacitance variations of the X electrodes X1 to Xn and the Y electrodes Y1 to Ym detected by scanning the X electrodes X1 to Xn and the Y electrodes Y1 to Ym N times (N is equal to or greater than 2);
adding the capacitance variations of the X electrode and Y electrode temporary storage units by X electrode and Y electrode capacitance variation adding units, respectively; and
calculating center coordinates of a position where a conductor touches the touch sensor unit by a center coordinates calculating unit by using the capacitance variations added by the X electrode and Y electrode capacitance variation adding units and detecting coordinates of the position.

4. The method of claim 3, wherein touch response units of the X electrodes X1 to Xn and touch response units of the Y electrodes Y1 to Ym are arranged such that the touch response units do not overlap each other in a direction of a display surface of a display.
